(19) United States
(12) Patent Application Publication
(10) Pub. No.: US 2017/0257935 A1
(43) Pub. Date: Sep. 7, 2017

(54) Intelligent Lighting System

(71) Applicants: Mark Hopperton, Ramona, CA (US); Michael Robert Hidock, San Diego, CA (US)

(72) Inventors: Mark Hopperton, Ramona, CA (US); Michael Robert Hidock, San Diego, CA (US)

(21) Appl. No.: 15/451,962

(22) Filed: Mar. 7, 2017

Related U.S. Application Data
(60) Provisional application No. 62/304,469, filed on Mar. 7, 2016.

(51) Int. Cl. H05B 37/02; F21K 9/66; H05B 33/08; F21K 9/272; H04W 4/00; F21K 9/278

(52) U.S. Cl. CPC H05B 37/0272; H04W 4/008; F21K 9/278; H05B 37/0281; H05B 33/0842; F21K 9/272; F21K 9/66; F21Y 2115/10

(57) ABSTRACT

An intelligent lighting system provides synchronization for lighting units having light emitting diodes within a flexible, light transmissive structure in connection with receiving lighting commands from a remote DMX controller. The system includes lighting units, a microcontroller and a receiver for wirelessly receiving the commands from the DMX controller. A process is implemented to achieve lighting unit execution synchronization as a result of calculating more accurate delay times, by an iterative method, in connection with executing DMX commands.

### CROSS-REFERENCE TO RELATED APPLICATIONS

The present application claims priority to U.S. Provisional Patent Application No. 62/304,469 filed on Mar. 7, 2016, entitled “Intelligent Lighting System,” the entire disclosure of which is incorporated by reference herein.

### BACKGROUND OF THE INVENTION

1. Field of Invention

The present invention relates to the field of DMX controllers and synchronized lighting devices.

2. Description of Related Art

DMX controllers were originally designed to tightly control DMX lighting fixtures in real-time. The DMX protocol, a standard for controlling lighting equipment and related accessories, repeatedly transmits up to 512 commands at over 100 times per second and is implemented in the DMX controller. This high speed allows the DMX controller to transmit commands allowing a lighting fixture to dim smoothly or fade from one color to another smoothly in direct response to the commands from the DMX controller. As lighting fixtures became more sophisticated, additional commands were created such as strobe and preset colors. These commands were still expected to be performed immediately upon reception of the command from the DMX controller.

In order to make efficient use of communication protocols that re-transmit data to control a new class of lighting fixtures, it has become necessary to reduce the transmission rate from hundreds of times a second to as low as one command every two or three seconds. In order to ensure reliable reception of every command to every lighting fixture, it is also necessary to introduce a delay between when the command is sent from the DMX controller to when the command is executed by the lighting fixture. In order for a lighting fixture to function in this type of environment, a new approach to sending DMX commands is required. [0005] There are cases in which a transmitting device will wirelessly send a series of commands to multiple receiving devices using packet retransmission that may include, among other communication technologies, Bluetooth, Bluetooth Low Energy (also referred to as Bluetooth LE or BLE) and TCP/IP. Each command is sent in an information packet. Many of these transmission technologies will rebroadcast the same information packet multiple times and on multiple frequencies within a window of time in order to assure that the packet is received. If multiple devices are receiving the same packet, each device could receive the packet at a different time due to interference or queuing. Receiving devices are not aware of which packet is received and thus timing errors are introduced. Any procedure that requires multiple devices to act upon packet information at the same time, i.e. synchronized devices, cannot depend upon the packets arrival time to coordinate any activity that should be done simultaneously.

Furthermore, there is a deficiency in the prior art for lighting devices that enable display of synchronized lighting and receiving and processing DMX instructions. While some existing DMX systems do have the ability to synchronize, DMX using transmission protocols with wireless systems, such as those using Bluetooth, Bluetooth LE and TCP/IP, do not.

Based on the foregoing, there is a need in the art for a system of synchronizing lights and a device for displaying synchronized lighting at public events.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 shows a cutawy view of the lighting fixture, according to an embodiment of the present invention.

FIG. 2 show a perspective detail view of a lighting unit, with two LEDs connected to a printed circuit board, within a clamshell.

FIG. 3 is a flowchart illustrating the synchronization process according to embodiments disclosed herein.

FIG. 4 is a diagram illustrating an example of the synchronization process described herein.

Applicable reference numbers have been carried forward.

### DETAILED DESCRIPTION OF PREFERRED EMBODIMENTS

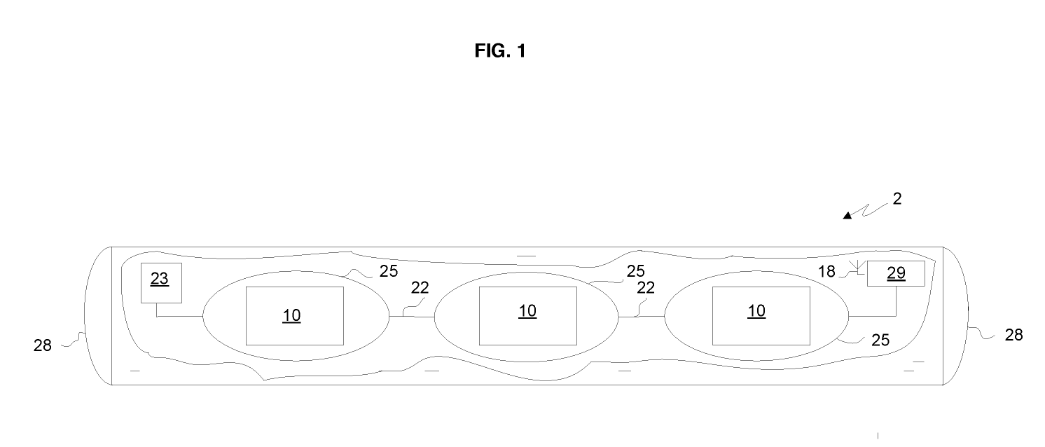

Preferred embodiments of the present invention and their advantages may be understood by referring to FIGS. 1-4, wherein like reference numerals refer to like elements.

The present invention discloses an intelligent lighting fixture capable of performing dimming and fading and other functions autonomously, controlled by a set of DMX slot definitions to control them. As lighting fixtures will be performing a fade over time, the command will have to include a length definition. The concept is that the lighting fixture will control its own emission for a period of time and will not be under constant control of the DMX controller.

FIG. 1 illustrates an exploded view of the lighting fixture, according to one embodiment of the invention. With reference to FIG. 1, the lighting fixture 2 has an elongated poly foam tube 5 with a plurality of lighting units 10 therein, each contained with clamshell 25. In one embodiment, the foam tube is a closed-cell foam elongated cylinder with a hollow channel substantially the length of the cylinder therein to accommodate the lighting units. The lighting fixture is modular and is adapted to tubes of different lengths and shapes. Such tubes may also be referred to as noodles or sleeves and they are contemplated as being deformable to accommodate taking various shapes and bends according to preference. In some embodiments, poly foam tube 5 is light transmissive.

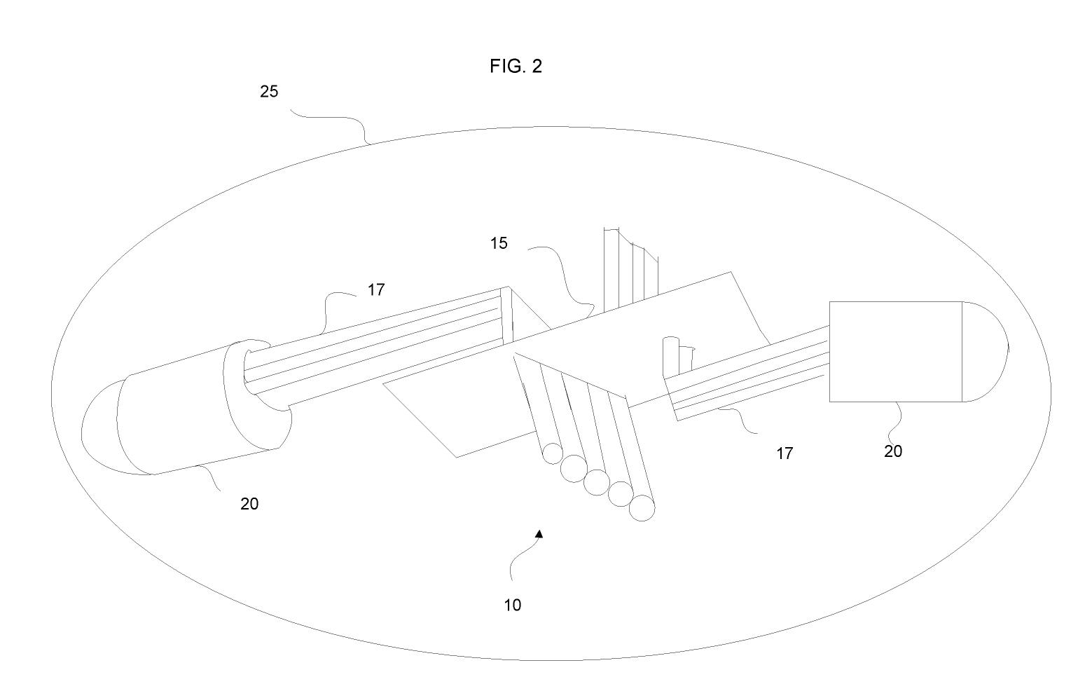

FIG. 2 show a perspective detail view of lighting unit 10 having a fixture with LEDs. Each lighting unit 10 has a lighting printed circuit board (PCB) 15 therein, accommodating connection to one or more LEDs 20, with two LEDs in one embodiment, and enclosed within a translucent clamshell 25 as shown in FIG.2. Optionally, lighting PCB 15 may have resistors to provide the correct power requirements and effects for the LEDs 20. In one embodiment, there is another PCB (not shown) on which BLE wireless controller 29 (e.g., a microcontroller) for controlling the LEDs 20 using firmware (not shown)) and antenna 18 lie. With reference back to FIG. 1, battery 23 is shown positioned at the opposite end of the tube 5 from BLE controller 29. In a preferred orientation for fixture 2 the battery end of fixture 2 is contemplated as being heavier that the end holding BLE controller 29 thereby allowing the heavier battery end to be in a low position with respect to the lighter antenna end, with antenna 18, which can be positioned at a higher position for better reception. Battery 23 may be rechargeable and, in one embodiment, a charge cable (not shown) for battery 23 may extend from the battery end of the fixture 2.

With reference to FIG. 1. lighting units 10 are connected by jumper wires 22 and connectors (not shown) to form a connected electrical system. The lighting fixture has a power source such as a battery 23, therein, also electrically connected to the electrical system. Wireless module 29 connected to lighting units 10 (forming the electrical system) is connected to antenna 18 for transmission and reception of signals from a DMX controller (not shown). Wireless module 29 provides control signals to each lighting unit 10.

Lighting unit 10, within the clamshell 25, is positioned within foam tube 5, and a poly foam cap 28 closes each end of foam tube 5. The clamshells 25 are pulled through the hollow of tube 5 and are distributed therethrough, remaining in position by means of a compression fit or retaining means such as barbs or hooks.

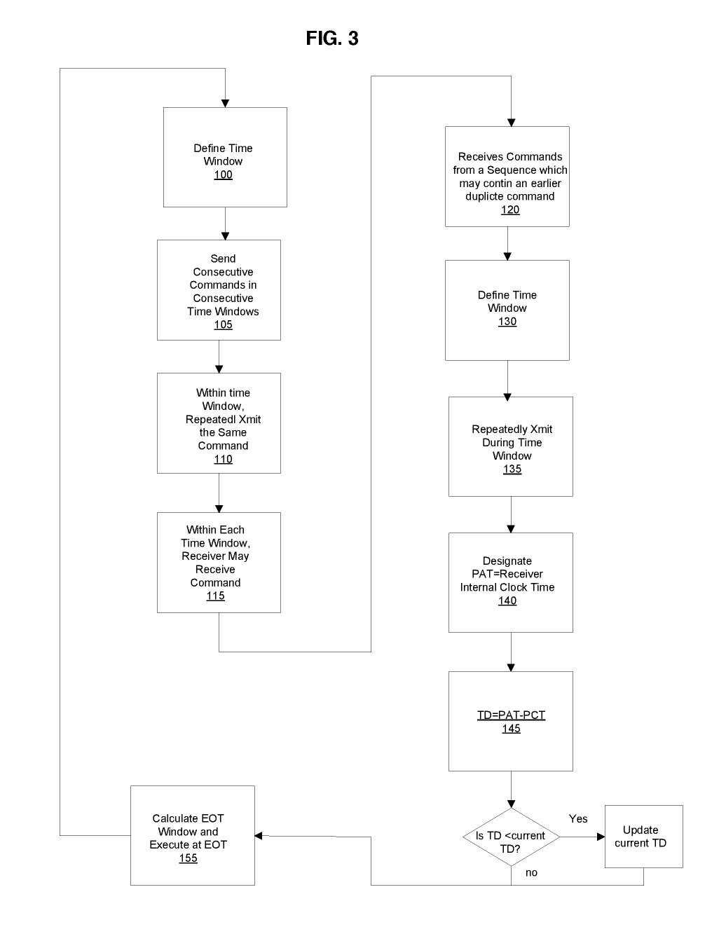

FIG. 3 is a flowchart illustrating the synchronization process according to embodiments disclosed herein. With reference to FIG. 3, a process to synchronize a plurality of smart lighting devices with repeating communication protocols is disclosed. DMX commands control the LED light emissions in each lighting unit. In step 100, a Time Window (TW) is defined. In step 105, consecutive commands are sent in consecutive Time Windows. In step 110, within a defined Time Window, the transmitting device will re-transmit the same command many times. In step 115, within each time window each receiver may randomly receive one of these duplicate transmissions and each receiver will not know which of the repeated transmissions it has received. In step 120, as each receiver receives the sequence of consecutive commands, it may receive an earlier duplicate transmission and eventually receive the first possible duplicate transmission.

In order to facilitate the synchronization of multiple lighting devices, in a further embodiment, in step 130 a Time Window is defined within which all receivers must receive a valid packet. The packet contains the command as well as the value of the transmitter's internal clock at the time the packet was constructed (PCT), Packet Construction Time.

In step 135 the transmitting device will repeatedly send the same packet many times within this Time Window. The contents of the packet do not change within this Time Window. As new commands are sent, this process loops.

Upon receiving the first packet or receiving a packet different from the previous packet, each device will set the Packet Arrival Time (PAT) to the value of the receivers internal clock when the package arrived in step 140, and calculate the Time Differential (TD) between the Packet Arrival Time (PAT) and the Packet Construction Time (PCT) in step 145. If the calculated Time Differential (TD) is less than the current recorded Time Differential (TD) value, then in step 150, update the current Time Differential (TD) to the calculated Time Differential (TD). In step 155, calculate the end of the time window and execute the command at that time. In step 160, this process continuously loops and will continue to minimize the Time Differential until all devices are synchronized. As a result of the following techniques, each receiving device will become more and more synchronized as the series of commands continues until, ultimately, all receiving devices are synchronized.

Calculations representative of the above follow:

#define TD = MaxInteger
loop
if TD> PAT−PCT then TD=PAT−PCT
Execute command at when receivers real-time clock equals TD+PCT+TW

Sliders provide how DMX is controlled in audience in synchronicity. In an embodiment, the intelligent lights are controlled (for example strobing, pulsing) through the use of eight slots, wherein example slider definitions are as follows:

Length of time: 0-255 Length of time of illumination in tenths of seconds i.e. 0.0-25.5 seconds

### Colors

Red: 0-255 Red intensity
Green: 0-255 Green intensity
Blue: 0-255 Blue intensity

### Frequency and Duration

Frequency with a value of 0 means do not Beat or Strobe, whereas 1-255 provides the beats per minute for strobe. Strobe Length may be varied by changing the value, for example, 1-255 value provides strobe length of between 0.5 seconds and 0.04 seconds inversely proportional to the value. Duration of 0 results in a strobe, whereas values of 1-255 dictate the ratio of time (out of 255) a beat will be lit.

### Color Modification

As example values for the color modification, 0 results in no modification, 1-63 results in adding twinkle to color, 64-127 is random, wherein color is individually overridden with random color, 128-191 results in twinkle+random, wherein twinkle is added to individually overridden random color, and 192-255 results in sparkle, wherein color and intensity are individually overwritten what rapid and random changes.

### Activate

0-99=blackout: send nothing to fixture, 100-127=set meaning set fade beginning color;

replace last color with current color while maintaining blackout, nothing sent to noodles, 128-191=snap, meaning send current settings to noodles without fade, 192-255=Fade, meaning send current settings to noodles with fading.

Slots seven and eight are designed to be use with buttons instead of sliders

### Color Modification (Example of Discrete Values)

50=Twinkle: Add Twinkle to Color (this may affect a range from 25-75, for example),

100=Random: Individually Override Color with Random Color (this may affect a range from 75-125, for example), 150=Twinkle+Random:Add Twinkle to Individually Overridden Random Color (this may affect a range from 125-175, for example), 200=Sparkle: Individually overwrite color and intensity what rapid and random changes.

### Activate (Example of Discrete Values)

100=Set: Set fade beginning color. Replace last color with current color while maintaining blackout, nothing sent to noodles (this may affect a range from 75-125, for example),

150=Snap: send current settings to noodles without fade (this may affect a range from 125-175, for example), 200=Fade: send current settings to noodles with fading (this may affect a range from 175-225, for example)

In a DMX Dual Channel Control embodiment, certain channels interact to provide additional functionality. In step 200, strobe and beat slot sliders are provided using two slots to modify a currently selected illumination with either a strobe or beat effect. In step 205, the two slots will be called frequency.

### Frequency and Duration

Each slot can either be zero or have a value resulting in 3 possible effects. When both frequency and duration equal zero, there is no effect. When both frequency and duration have a value, resulting in modification of the illumination with a beat effect.

Duration proportionately assigns a duration value (1-255) to the amount of time the beat will be lit. For example, a value of 64 results in 25% lit, a value of 128 results in 50% lit, on a value of 192 the light is 75% lit. Where only frequency has a value, the illumination may be modified with a strobe affect. Frequency sets the strobing speed (Slowest to Fastest) proportionately to frequency value (1-255). Where only duration has a value, the illumination is modified with pulsing affect. Where the frequency is zero, the duration is set the Pulsate speed (Slowest to Fastest) in proportion with the duration value (1-255).

Example of device #2

| | | | | | Calculation of eTD | CET | DCB |
|---|---|---|---|---|---|---|---|
| | | | | | if bTD > PAT − PCT then eTD = | CET = | DCB = |
| Command | bTD | TW | PCT | PAT | PAT − PCT | (PCT + eTD + TW) | (CET − PAT) |
| #1 Received | 99 | 16 | 59 | 86 | If 99 > 27 (86 − 59) Then eTD = 27 | 102 (59 + 27 + 16) | 16 (102 − 86) |
| #2 Received | 27 | 16 | 90 | 123 | If 27 > 33 (123 − 90) Else eTD = 27 | 133 (90 + 27 + 16) | 10 (133 − 123) |
| #3 Received | 27 | 16 | 126 | 151 | If 27 > 25 (151 − 126) Then eTD = 25 | 167 (126 + 25 + 16) | 16 (167 − 151) |
| #N Received | 25 | 16 | 163 | 194 | If 25 > 31 (194 − 163) Else eTD = 25 | 204 (163 + 25 + 16) | 10 (204 − 194) |

TW = Time Window
PCT = Packet Construction Time
PAT = Packet Arrival Time
bTD = beginning Time Differential
eTD = ending Time Differential (if bTD > PAT − PCT then eTD = PAT − PCT)
CET = Command Execution Time (CET = PCT + eTD + TW)
DCB = Delay Command By (DCB = CET − PAT)

### EXAMPLE

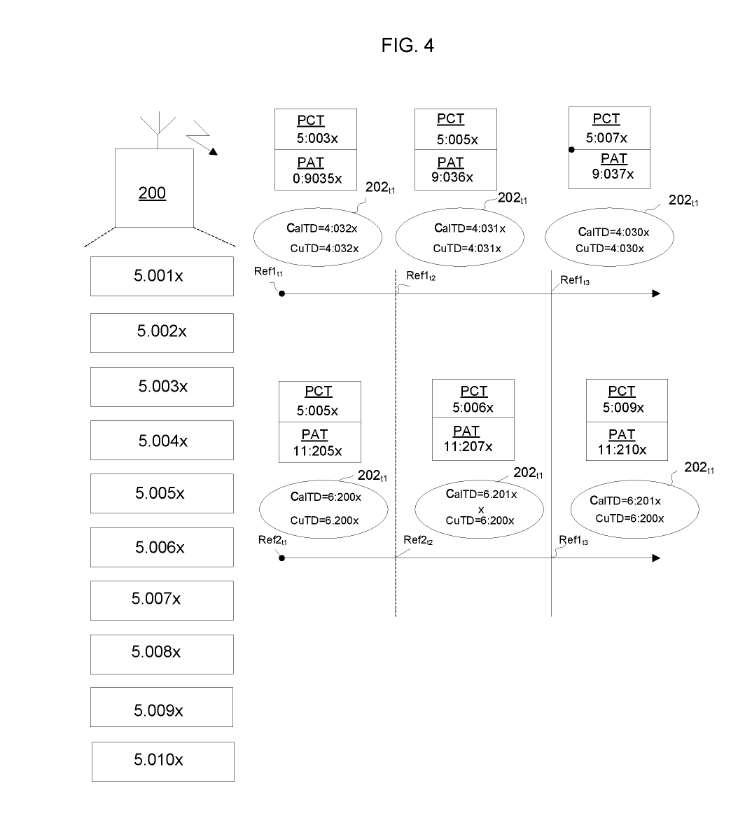

The synchronization process described above is further demonstrated for some embodiments using Bluetooth Low Energy (Bluetooth LE or BLE) with reference to FIG. 4. FIG. 4 is a diagram illustrating an example of the synchronization process described above. The BLE specification defines a BLE advertising packet that includes a variable payload. An advertisement may be broadcast/multicast by a beacon during an advertising interval, that has a user defined fixed interval of between 20 ms and 10.24 s and a pseudo-random delay of between 0 ms and 10 ms. In some embodiments, a broadcast packet contains both the packet creation time (PCT) referenced with respect to the internal clock at the broadcasting/multicasting beacon and the duration of the fixed time interval referenced from the broadcast/multicast of the first packet in a broadcast/multicast sequence which is substantially the PCT of the first packet. Beacon 200 broadcasts/multicasts a discovery frame with a fixed interval of 0.010x ms with x being a scaling factor sufficient to define the fixed interval from between 20 ms and 10.24 seconds. This broadcast/multicast contains an advertisement which may contain user defined content. For instance, a command may be broadcast/multicast from the beacon instructing the lighting within a noodle to change to a particular color, hue, etc. Noodle 202 receives transmissions from beacon 200 and it is shown in FIG. 4 with respect to events occurring during time line Ref1 in connection with times Ref1t1, Ref1t2 and Ref1t3. Noodle 210 is an additional noodle receiving transmissions from beacon 200 and it is shown in FIG. 4 with respect to events occurring during time line Ref2 in connection with times Ref2t1, Ref2t2 and Ref2t3 as noodle 210 has its own clock separate from noodle 202. Packets, numbered according to packet creation times (PCT), are shown numbered from 5.001x to 5.010x (x being the scaling factor discussed above). In some environments, all packets broadcast to noodles may not be received due to interference or other phenomenon. For the present example, noodle 202 receives packet 5.003x having a PCT of 5.003x. This packet is received at noodle 202, referenced to internal clock Ref1, at time Ref1t1, which is time 9.035 as shown on the REF1 time line. The calculated time differential (calTD) is therefore 4.032x as indicated on FIG. 4 within noodle 202 at time t1 (202t1). For the initial time differential in a transmitted sequence, from a beacon, the current time differential cuTD is set equal to the calculated time differential. Noodle 202 also receives the fixed interval time length 0.010x ms as referenced from the PCT of the first packet transmission in a sequence. Given the foregoing, a packet 202 will execute the received command in connection with noodle's internal clock reaching the value of TD+PCT+TW. With respect to the receipt of packet 5:003x, TD+PCT+TW equals (4.032+5.003+0.008)x, which is 9.043x. The received command will execute at 9:043x should an earlier execution time not be determined, The time window (TW) was determined in connection with determining that the packet receipt of 5:003x was created 0.002x past the initial packet creation time (PCT), 5:001x, of the first packet 5:001x. At time Ref1t2, noodle 202 receives packet 5:005x at noodle internal clock time of 9:036. The current time differential is 4:32x, the calculated time differential is 4:031x. Therefore, since calTD<cuTD, the calculated TD replaces the value of cuTD. The calTD and new cuTD=4:031x are shown within noodle 202 at time t2 (202t2). At Ref1t3, noodle 202 receives packet 5:007x with at 9:037x (PAT) with a PCT of 5:007x. The calTD=4:030x and since this is less than the cuTD of 4:031x, the cuTD is updated to 4:030. The command received at 5:007x will execute at TD+PCT+TW=(4:030+5:007+0.004)x=9:041x should an earlier execution time not be determined.

Calculated time differentials and current time differential numbers are shown in FIG. 4 for noodle 210 having a clock not synchronized with that of noodle 202. As with noodle 202, the calTD and cuTD values are shown in noodle 210 at times t1, t2 and t3 (210ₜ₁, 210ₜ₂ and 210ₜ₃). Despite different internal clocks for noodles 202 and 210, a command broadcast in a given sequence will execute after a time delay in receiving the command as measured by an internal clock at the noodle and accounting for a time window figured from the packet creation time of the first packet in the sequence. After the broadcast of a command in a first sequence, a sequence with a different command may be broadcast from a beacon to a noodle. Each command may contain several instructions for execution at the BLE microcontroller. With receipt of each command, synchronized execution of commands potentially improves while accounting for the smallest potential time difference between command dispatch to a noodle and command arrival at a noodle. The foregoing allows synchronized action of lights in a DMX system that would otherwise not operate in a synchronized manner.

The invention has been described herein using specific embodiments for the purposes of illustration only. It will be readily apparent to one of ordinary skill in the art, however, that the principles of the invention can be embodied in other ways.

For instance, the foregoing embodiments may be accomplished using WiFi and a WIFi controller in place of Bluetooth™ controller. The foregoing may also be implemented as computer executable program executable by a DMX controller. Therefore, the invention should not be regarded as being limited in scope to the specific embodiments disclosed herein, but instead as being fully commensurate in scope with the following claims.

We claim:

1. A lighting fixture comprising;
a plurality of lighting units within a sleeve, said sleeve at being capable of allowing, at least some, light to pass therethrough;
a processor within said sleeve;
a communications receiver;
an antenna connected to the processor;
a memory connected to the processor;
a timing unit connected to the processor; and
a battery, being at least capable of powering the plurality of light sources.

2. The lighting fixture as recited in claim 1 which further includes an end cap at each end of the fixture, said end cap being adapted to connect to an end of another communication fixture.

3. The lighting fixture as recited in claim 1 which is further constructed from a flexible material.

4. The lighting fixture as recited in claim 1 wherein each lighting unit comprises one or more light emitting diodes (LEDs).

5. The lighting fixture as recited in claim 1 wherein said communications receiver comprises a communications module operable in the range of approximately 2.4 to 2.4835 GHz.

6. The lighting fixture as recited in claim 5 wherein said module is operable to form a personal area network for the plurality of lighting units.

7. The lighting fixture as recited in claim 1 which further includes a controller operable in frequency bands, selected from a band consisting of 2.4, 3.6, 5, and 60 GHz frequency bands, connected to the communications receiver.

8. The lighting fixture as recited in claim 1 wherein said processor is a microcontroller.

9. The lighting fixture as recited in claim 1 wherein the sleeve is translucent.

10. The lighting fixture as recited in claim 1 wherein the lighting unit is elongated so as enclose said lighting units disposed within said sleeve along an axial line through each end cap.

11. A method for synchronizing lighting among a plurality of lighting units, comprising:
a. wirelessly receiving from a transmitter, a command containing an internal clock time corresponding to the time of transmission, of the command, from the transmitter;
b. designating the arrival time of the command as the time of receipt, of the command, at the lighting fixture;
c. designating a calculated time differential as the difference between the time of arrival of the command and the time of transmission, from the transmitter, of the command;
d. determining whether the calculated time differential is less than the current time differential;
e. updating the current time differential with the value of the calculated time differential if the calculated time differential is less than the current time differential; and
f. executing the command in connection with calculating an end of a window of time during which commands are to be received from the transmitter.

12. A method for synchronizing lighting among a plurality of lighting units as recited in claim 11 wherein commands are received from a DMX controller.

13. A method for synchronizing lighting among a plurality of lighting units as recited in claim 11 wherein the command is selected from the group of commands controlling, color, frequency and duration; color modification; activation time; and a combination thereof.

14. A method for synchronizing lighting among a plurality of lighting units as recited in claim 11 wherein said command is included within one or more packet communications.

15. A lighting fixture comprising;
a plurality of lighting units within a noodle, said noodle being capable of allowing, at least some, light to pass therethrough;
a processor within said noodle;
a communications receiver;
an antenna connected to the processor;
a memory connected to the processor;
a timing unit connected to the processor;
means for synchronizing the operation of the plurality of lighting units; and
a battery, being at least capable of powering the plurality of light sources.

16. A lighting fixture as recited in claim 15 wherein said means for synchronizing the operation of the plurality of lighting units operates in conjunction with commands from a DMX controller received by said communications receiver.

17. A lighting fixture as recited in claim 15 wherein said light units include a pair of light emitting diodes LEDS with connections, disposed at right angles, to a printed circuit board.

18. A lighting fixture as recited in claim 15 wherein said noodle further includes an end cap at each end of the fixture, said end cap being adapted to connect to an end of another communication fixture.

19. The lighting fixture as recited in claim 15 wherein each lighting unit comprises one or more light emitting diodes (LEDs).

20. The lighting fixture as recited in claim 15 which is further constructed from a flexible material.

21. A computer-readable, non-transitory, programmable product, for use in conjunction with a DMX controller comprising code for causing a processor to do the following:
receive from a transmitter, a command containing an internal clock time corresponding to the time of transmission, of the command, from the transmitter;
designate the arrival time of the command as the time of receipt, of the command, at the lighting fixture;
designate a calculated time differential as the difference between the time of arrival of the command and the time of transmission, from the transmitter, of the command;
determine whether the calculated time differential is less than the current time differential;
update the current time differential with the value of the calculated time differential if the calculated time differential is less than the current time differential; and
execute the command in connection with calculating an end of a window of time during which commands are to be received from the transmitter.
